(19) United States
(12) Patent Application Publication
(10) Pub. No.: US 2010/0322725 A1
(43) Pub. Date: Dec. 23, 2010

(54) Positioning and cooling device for vertical surface drilling

(75) Inventor: Weixiang Ren, Zhejiang Province (CN)

Correspondence Address: YH CHAN, 42 PIN OAKS DRIVE, PHOENIXVILLE, PA, 19460, US

(73) Assignee: Hangzhou Bofeng Diamond Tools Co., Ltd., Zhejiang Province (CN)

(21) Appl. No.: 12/540,383

(22) Filed: Aug. 13, 2009

(30) Foreign Application Priority Data
Jun. 18, 2009 (CN) 200910099566.3

(51) Int. Cl. B23B 49/02

(52) U.S. Cl. 408/56; 408/72 R; 408/241 G

(57) ABSTRACT

The present invention discloses a positioning and cooling device for vertical surface drilling which comprises a first cup body, a second cup body and a drill bit sleeve. The drill bit sleeve is disposed on the first cup body and the second cup body is received in the first cup body. The first cup body is in shape of a rectangular cylinder with an open end at a first end thereof, and a positioning hole with a size corresponding to that of the drill bit sleeve is disposed at a central position of the first cup body. The second cup body is in shape of a rectangular cylinder with a size slightly smaller than that of the first cup body, and the second cup body has an open end at a first end thereof and a plurality of water injection holes at a second end thereof which is opposite to the open end. To use the present invention, the drill bit sleeve is first inserted into the positioning hole on the first cup body. The first cup body is then affixed onto the vertical wall or work surface which requires drilling by means of a double-sided tape or other adhesives. At the same time, the drill bit sleeve is ensured to be perpendicular to the wall or work surface, and the drill bit sleeve is aligned with the position where the hole is to be drilled. Then, fill the second cup body with water and insert the second cup body to the first cup body. Water then drips into the drill bit sleeve from the second cup body and cools the drill bit instantly. The present invention solves the technical problem of positioning and cooling for vertical surface drilling. It is of simple structure, easy to use and worth promoting.

### BACKGROUND OF THE INVENTION

The present invention relates to a positioning and cooling device for drilling which is an auxiliary device for drilling apparatus and more particularly pertains to a positioning and cooling device for vertical surface drilling.

In the fields of housing renovation, construction and processing of machine parts, it is frequently necessary to drill holes on wall or work surfaces in vertical or slanted condition. Take the example of drilling a hole on a vertical wall surface, when there is a higher requirement on the precision of the position of the hole and the hole is required to be perpendicular to the wall surface, it would normally rely on the skills and proficiency level of the drilling apparatus operator. To date, there is no corresponding auxiliary positioning device for drilling. In the field of processing of machine parts, precised positioning is usually done by positioning molds of machine parts, but there is no effective cooling device for drilling apparatus which may be used to increase drilling efficiency. Normally, the drilling apparatus is cooled naturally, but this is obviously disadvantageous for the enhancement of drilling efficiency. Furthermore, when the drilling apparatus is in frequent use, continued use of the apparatus when it could not be effectively cooled down causes relatively huge wear and tear on the drill bit of the drilling apparatus, thereby reducing its durability. Therefore, there is a need for an effective auxiliary device for the positioning and cooling of drilling apparatus.

### BRIEF SUMMARY OF THE INVENTION

It is an object of the present invention to provide a positioning and cooling device for vertical surface drilling which could achieve precise positioning of the drilling position and also cool the drill bit in a water cooling manner, thereby effectively increasing the precision of the drilling position and cooling the drill bit, elongating the life span of the drill bit and increasing the frequency of use per unit interval.

To attain this, the present invention adopts the following technical proposal:

A positioning and cooling device for vertical surface drilling which comprises a first cup body, a second cup body and a drill bit sleeve. The drill bit sleeve is disposed on the first cup body, and the second cup body is received in the first cup body.

The first cup body is in shape of a rectangular cylinder with an open end at a first end thereof and a positioning hole with a size corresponding to that of the drill bit sleeve disposed at a central position of the first cup body.

The second cup body is in shape of a rectangular cylinder with a size slightly smaller than that of the first cup body. The second cup body has an open end at a first end thereof and a plurality of water injection holes at a second end thereof which is opposite to the open end.

The drill bit sleeve has a circular cross section with a size corresponding to that of the positioning hole at the central position of the first cup body. The drill bit sleeve has a cutting face and a curved face opposite thereto each disposed with a water-passing hole in a non-aligning manner with each other.

The positioning hole is in circular shape and with a size corresponding to the drill bit sleeve. The circular positioning hole has a chord which is parallel to the open end of the first cup body and disposed nearer to the open end.

To further elaborate, the size of the second cup body is smaller than that of the first cup body so that the second cup body may be inserted into the first cup body. The size of the positioning hole corresponds to that of the drill bit sleeve so that the drill bit sleeve may be inserted into the positioning hole. Both the positioning hole and the drill bit sleeve are in circular shape. When drilling a hole, the drill bit sleeve inserted into the positioning hole is fixed and will not be rotated by the drill bit. The water-passing holes on the drill bit sleeve are disposed in a non-aligning manner with respect to each other so that water passing through the water-passing hole on the cutting face of the drill bit sleeve into the drill bit sleeve will have sufficient contact with the drill bit in the drill bit sleeve before leaving through the water-passing hole on the curved face.

To use the present invention, the drill bit sleeve is first inserted into the positioning hole on the first cup body. The first cup body is then affixed onto the vertical wall or work surface which requires drilling by means of a double-sided tape or other adhesives. At the same time, the drill bit sleeve is ensured to be perpendicular to the wall or work surface, and the drill bit sleeve is aligned with the position where the hole is to be drilled. Then, fill the second cup body with water and insert the second cup body to the first cup body.

In comparison with the available prior art, the present invention has the following technical advantages:

1. Precise positioning of the drill position: The positioning and cooling device for vertical surface drilling of the present invention cannot move after being affixed to the vertical wall or work surface, thereby achieving higher precision in the drilling position which is corresponding to the drill bit sleeve.

2. Good cooling effect: As water has a high thermal capacity and is easy to obtain, cooling the drill bit by water cooling could achieve effective cooling with negligible costs.

3. Prevent water pollution: As waste water after use will be stored and collected in the first cup body, no water pollution will be caused.

### BRIEF DESCRIPTION OF THE DRAWINGS

FIG. 1 shows a structural view of an embodiment of the present invention.

FIG. 2 shows a structural view of the first cup body of an embodiment of the present invention.

FIG. 3 shows a structural view of the second cup body of an embodiment of the present invention.

FIG. 4 shows a structural view of the drill bit sleeve of an embodiment of the present invention.

The labels in the drawings are as follows: 1: first cup body; 11: open end; 12: positioning hole; 2: second cup body; 21 open end; 22: water injection hole; 3: drill bit sleeve; 31: water-passing hole; 32: cutting face.

### DETAILED DESCRIPTION OF THE INVENTION

The technical proposal of the present invention is further described with the accompanying drawings and embodiment.

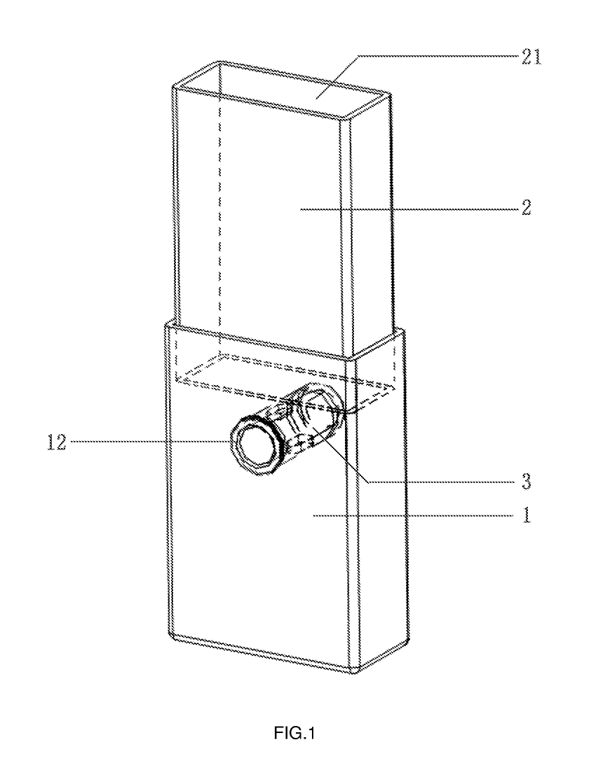

FIG. 1 shows a structural view of an embodiment of the present invention. The positioning and cooling device for vertical surface drilling of the present invention comprises a first cup body 1, a second cup body 2 and a drill bit sleeve 3, wherein the drill bit sleeve 3 is disposed at the first cup body 1, and the second cup body 2 is received in the first cup body 1.

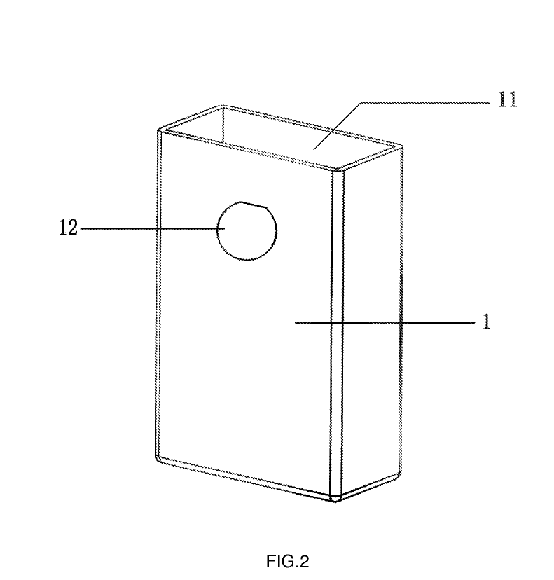

FIG. 2 shows a structural view of the first cup body 1 of an embodiment of the present invention. The first cup body 1 is in shape of a rectangular cylinder with an open end 11 at a first end thereof, and a positioning hole 12 with a size corresponding to that of the drill bit sleeve 3 is disposed at a central position of the first cup body. The positioning hole 12 is in circular shape and with a size corresponding to the drill bit sleeve 3. The circular positioning hole 12 has a chord which is parallel to the open end 11 of the first cup body 1 and disposed nearer to the open end 11.

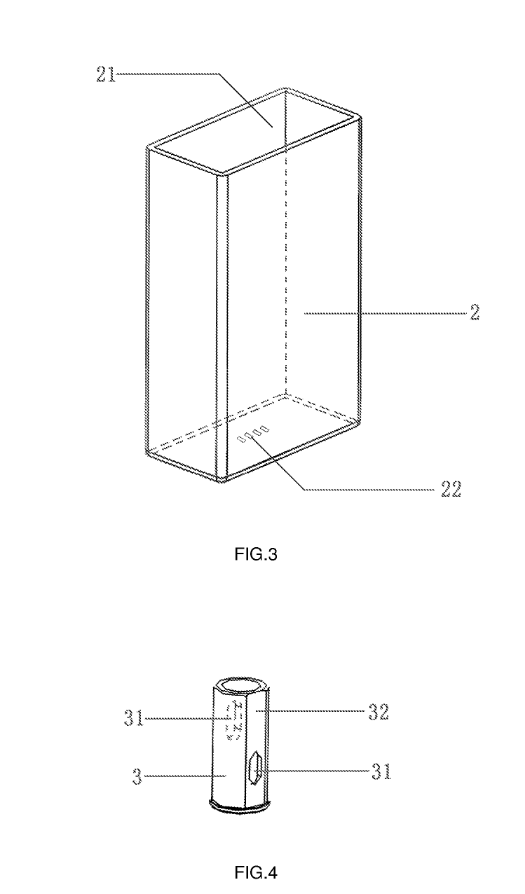

FIG. 3 shows a structural view of the second cup body 2 of an embodiment of the present invention. The second cup body 2 is in shape of a rectangular cylinder with a size slightly smaller than that of the first cup body 1. The second cup body 2 has an open end 21 at a first end thereof and a plurality of water injection holes 22 at a second end thereof which is opposite to the open end 21.

FIG. 4 shows a structural view of the drill bit sleeve 3 of an embodiment of the present invention. The drill bit sleeve 3 has a circular cross section with a size corresponding to that of the positioning hole 12 at the central position of the first cup body 1. The drill bit sleeve 3 has a cutting face 32 and a curved face opposite thereto each disposed with a water-passing hole 31 in a non-aligning manner with respect to each other.

To use the present invention, the drill bit sleeve 3 is first inserted into the positioning hole 12 on the first cup body 1. The first cup body 1 is then affixed onto the vertical wall or work surface which requires drilling by means of a double-sided tape or other adhesives. At the same time, the drill bit sleeve 3 is ensured to be perpendicular to the wall or work surface, and the drill bit sleeve 3 is aligned with the position where the hole is to be drilled. Then, fill the second cup body 2 with water and insert the second cup body 2 to the first cup body 1. As waste water after use of the positioning and cooling device for vertical surface drilling of the present invention will be stored and collected in the first cup body 1, no water pollution will be caused.

What is claimed is:

1. A positioning and cooling device for vertical surface drilling which comprises a first cup body (1), a second cup body (2) and a drill bit sleeve (3), characterized in that the drill bit sleeve (3) is disposed on the first cup body (1), and the second cup body (2) is received in the first cup body (1).

2. A positioning and cooling device for vertical surface drilling as in claim 1, characterized in that the first cup body (1) is in shape of a rectangular cylinder with an open end (11) at a first end thereof, and a positioning hole (1 2) with a size corresponding to that of the drill bit sleeve (3) is disposed at a central position of the first cup body.

3. A positioning and cooling device for vertical surface drilling as in claim 1, characterized in that the second cup body (2) is in shape of a rectangular cylinder with a size slightly smaller than that of the first cup body (1), and the second cup body (2) has an open end (21) at a first end thereof and a plurality of water injection holes (22) at a second end thereof which is opposite to the open end (21).

4. A positioning and cooling device for vertical surface drilling as in claim 1, characterized in that the drill bit sleeve (3) has a circular cross section with a size corresponding to that of the positioning hole (1 2) at the central position of the first cup body (1); the drill bit sleeve (3) has a cutting face (32) and a curved face opposite thereto each disposed with a water-passing hole (31) in a non-aligning manner with respect to each other.
